(19) United States
(12) Patent Application Publication
(10) Pub. No.: US 2010/0026082 A1
(43) Pub. Date: Feb. 4, 2010

(54) WHEEL COVERING SYSTEM

(75) Inventor: FENTON A. LIFFICK, CHINO, CA (US)

Correspondence Address: FULWIDER PATTON LLP, HOWARD HUGHES CENTER, 6060 CENTER DRIVE, TENTH FLOOR, LOS ANGELES, CA, 90045, US

(73) Assignee: PRESTIGE AUTOTECH CORPORATION, CHINO, CA (US)

(21) Appl. No.: 12/181,622

(22) Filed: Jul. 29, 2008

(51) Int. Cl. B60B 7/14

(52) U.S. Cl. 301/37.376

(57) ABSTRACT

A wheel covering system for attachment to a vehicle axle, in which the axle has a plurality of externally threaded lugs for attaching a wheel. The system includes a mounting member configured to be removably attached to the axle. A plurality of combination nuts, each nut including a bore with internal threads configured to mate with external threads on one of the lugs, being configured to attach the wheel to the axle; an external hexagonal portion for torquing the combination nut; an external threaded portion configured to pass through one of the holes in the mounting member, and also configured to receive a nut for attaching the mounting member to the combination nut.

### BACKGROUND OF THE INVENTION

The present application relates to ornamental wheel covers, in particular to wheel cover assemblies that are suitable for affixing to vehicles such as heavy trucks, or rigs, and the like.

The motor vehicular transport industry today is a vibrant part of the economy, and many large transport trucks and rigs are privately owned. Indeed, many a large rig is the effective home of its private owner, providing onboard computers, communication systems, televised entertainment, and sleeping quarters. Ornamentation of the exterior has become an important aspect of personal ownership. Accordingly, the fitting of ornamental wheel covers over the wheels of large rigs and trucks has become widespread in recent years.

Unfortunately, the devices and methods used to attach ornamental cover assemblies over the wheels of large vehicles suffer from various shortcomings. Commonly, some devices for attaching ornamental covers over wheels have relied upon outwardly extending threaded lugs which are typically provided on the axle for attaching the wheel to the hub. This method may have the disadvantage of making the integrity of the wheel attachment structure dependent upon the viability of a foreign structure that was not part of the vehicle manufacturer's original wheel attachment design. The addition of foreign structure to the original wheel attachment assembly may lead to shortcomings, and indeed, may lead to denial of insurance coverage where the shortcomings are attributable to structure foreign to the original vehicle design. Additional problems may arise should the vehicle be subject to inspection by local, state, or federal authorities. Some inspectors may require that ornamental wheel covers be removed to present a clear view of the wheel attachment system. Removal of the covers may require removal of each wheel first, and may require the vehicle to be jacked up, on a wheel by wheel basis, to take the load off each wheel while the wheels and covers are removed, causing considerable inconvenience.

Accordingly, there is a need for an improved structure and method of affixing ornamental wheel covers over wheels of vehicles such as trucks. The present invention addresses these and other needs.

### SUMMARY OF THE INVENTION

According to a preferred embodiment of the invention, there is described a wheel covering system that provides a sturdy and robust system for attaching an ornamental wheel cover over a wheel of a large vehicle such as a truck or rig, capable of withstanding the kind of impact load that a wheel cover might experience over its lifetime, yet being easy to attach, and removable without interfering with the attachment of the wheel to the axle.

In a preferred embodiment, a wheel covering system is described for attachment to a vehicle axle, in which the axle has a plurality of externally threaded lugs for attaching a wheel. The system comprises an ornamental cover configured to be positioned adjacent the wheel. A mounting member is provided, configured to be removably attached to the axle after the wheel is attached to the axle. The mounting member has a distal end and a proximal end, wherein the distal end defines a plurality of holes and wherein the proximal end is configured to attach the ornamental cover to the mounting member. A plurality of combination nuts are provided, characterized in that each combination nut includes a bore with internal threads configured to mate with external threads on one of the lugs; an external hexagonal portion for torquing the combination nut onto a lug to attach the wheel onto the axle; and an external threaded portion configured to pass through one of the holes in the mounting member, and to receive a nut for attaching the mounting member to the combination nut.

In one aspect of the invention, the combination nut defines a shoulder between the external threaded portion and the external hexagonal portion, the shoulder being sized to not pass through one of the holes in the mounting member, whereby the shoulder acts as a support to the mounting member. In another aspect of the invention, the combination nut defines a splayed portion at a terminal end of the combination nut, the splayed portion having a larger diameter than the hexagonal portion.

In another facet, the invention includes a method of attaching an ornamental hub to a vehicle axle, the axle having a plurality of externally threaded lugs. The method comprises inserting the threaded lugs through holes in a wheel so that the wheel is adjacent the axle. A combination nut is threaded onto the external thread of each lug to attach the wheel to the axle, each combination nut having both an internal threaded portion and an external threaded portion. The external threaded portion of each combination nut is inserted through a respective hole in a mounting member so that the mounting member is adjacent the wheel. A holding nut is threaded onto the external threaded portion of each combination nut to attach the mounting member to the combination nuts. At least one stud extending proximally from the mounting member is inserted through a hole in the ornamental hub so that the ornamental hub is adjacent the mounting member. A nut is threaded onto the stud to attach the ornamental hub to the mounting member, whereby the ornamental hub is attached to the axle.

In another aspect, inserting at least one stud through a hole in the ornamental hub includes inserting two studs, each through a respective hole in the ornamental hub. In yet another aspect, the invention further includes threading a nut onto each of the at least one studs to firmly attach the ornamental hub to the mounting member. In yet another aspect, the invention further includes inserting a spindle, centrally positioned on and extending proximally from the mounting member, through a hole in the ornamental hub, such that the spindle enters the hole before the studs enter the respective holes in the ornamental hub.

In a final aspect of the invention, threading a combination nut onto the external thread of each lug includes selecting a combination nut with a shoulder at a desired position along the length of the combination nut, such that the shoulder provides support to the mounting member.

These and other advantages of the invention will become more apparent from the following detailed description thereof and the accompanying exemplary drawings.

### BRIEF DESCRIPTION OF THE DRAWINGS

FIG. 1 is a perspective view of a typical steering wheel attached to an hub of a truck.

FIG. 2 is a vertical sectional view of a mounting member having features of the present invention.

FIG. 3 is a plan view of the mounting member of FIG. 2.

FIG. 4 is an elevational view of combination nut having features of the present invention.

FIG. 5 is a sectional view of the nut of FIG. 4.

FIG. 6 is a plan view of the nut of FIG. 4.

FIG. 7 is the wheel of FIG. 1, including the mounting member of FIGS. 2 and 3 and the combination nuts of FIGS. 4-6, shown in exploded configuration.

FIG. 8 is a vertical sectional view of the wheel in FIG. 1, including a wheel covering system having features of the present invention.

FIG. 9 is an expanded view of the central portion of FIG. 8.

### DETAILED DESCRIPTION OF THE PREFERRED EMBODIMENTS

With reference to the drawings which are by way of example and not limitation, a wheel cover assembly and attachment system is disclosed having features of the wheel covering system of the present invention.

In setting forth the features of the present invention, there will first be described a cover assembly of a preferred embodiment that is structured for incorporation with the wheel covering system of the present invention. Second, there will be described a type of heavy truck hub structure that a wheel cover assembly will commonly encounter for attachment. Third, there will be described a preferred embodiment of an attachment system structured for incorporation with the wheel covering assembly of the present invention in the context of the described truck hub.

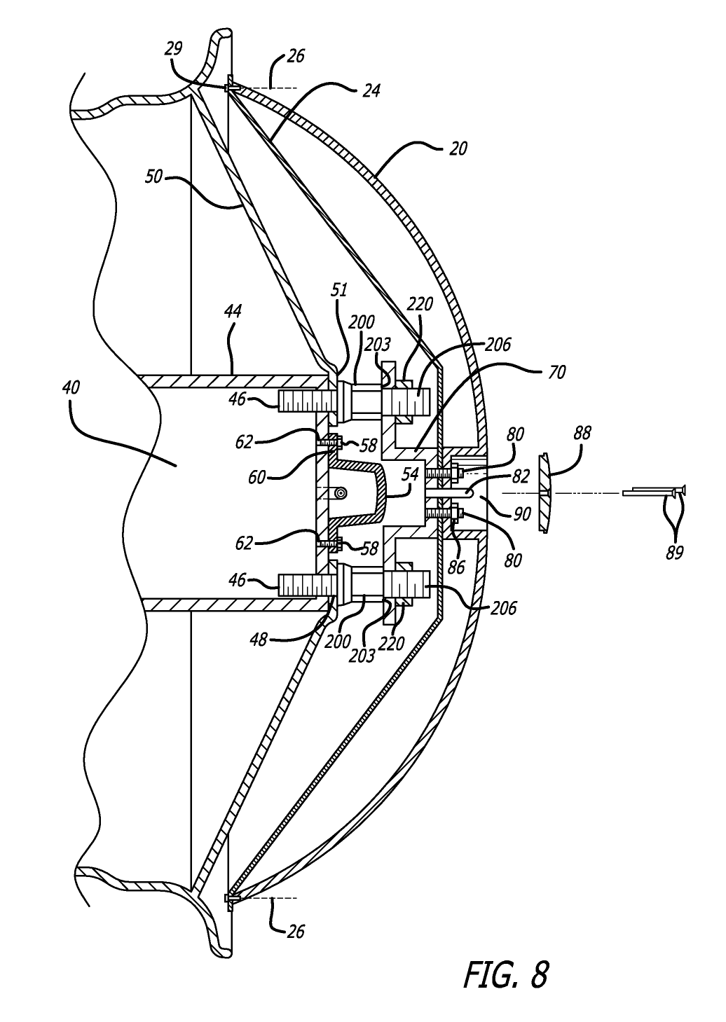

Turning now to a first embodiment of a wheel cover assembly of the present invention, as best seen in FIG. 8, an ornamental outer cover adapted for attachment according to the present invention is generally indicated by the numeral 20. Where the cover 20 is intended for attachment to a large vehicle such as a truck or rig, it is beneficially made of cast aluminum, and may weigh as much as about 15 to 30 pounds. This substantial weight gives the cover 20 considerable durability, able to withstand the occasional impact that is inevitable over the lifetime of a cover.

In a preferred embodiment, the cover 20 has openings (not shown in the figures) that give the cover a visible depth to one viewing the cover attached to a wheel. To enhance this visible depth, a second cover element is provided, being a foil sheet 24 specially made to have enhanced reflective properties on one side, preferably out of aluminum or stainless steel and in the range of 0.5 to 1 mm thick. The foil sheet 24 is placed distal to the outer cover 20 with the reflective side facing the exterior. In this way, one viewing the cover 20 looks through the openings in the cover 20 onto the reflective foil sheet 24 with the effect that the foil obstructs the view onto the unattractive structural details of the wheel attachment system, and reflects light to give an overall attractive ornamental appearance. The combination of cover 20 and foil 24 is referred to as a cover assembly, in this and in further embodiments.

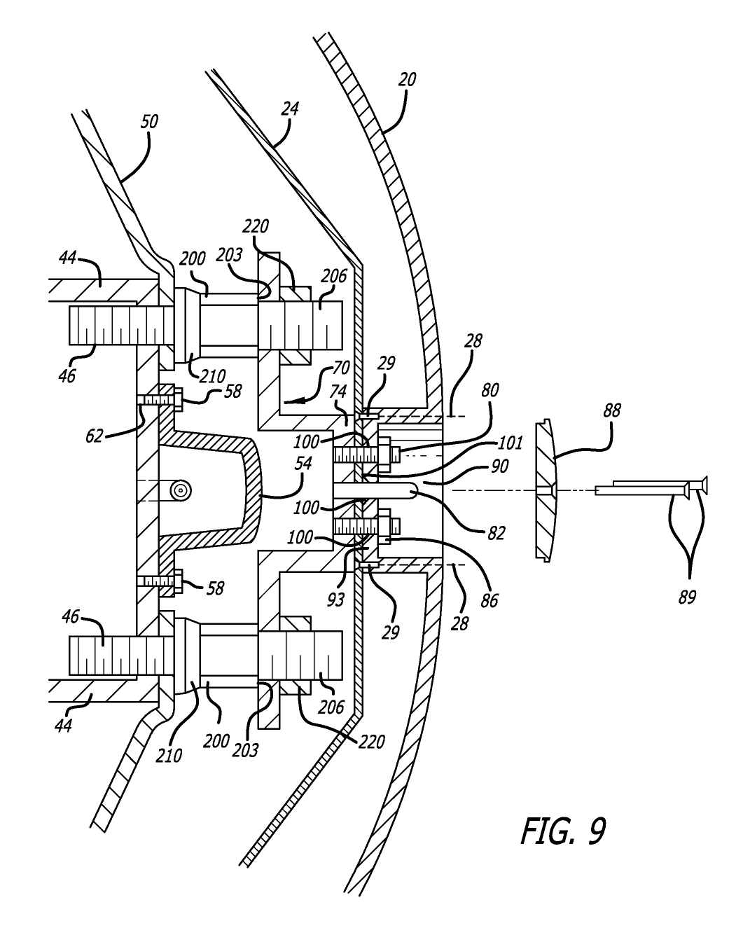

In a preferred embodiment, an outer circumferential rim of the inner foil 24 may be configured to contact the ornamental cover 20 along an outer circumferential line 26 (FIG. 8), and also along an inner circumferential line 28 (seen in FIG. 9). Matching holes may be drilled into the foil 24 and cover 20 along both the inner and outer lines of contact 26, 28 at points spaced apart, so that tapping screws 29 may be inserted through the foil 24 and screwed into the cover 20, to fixedly attach the foil 24 to the cover 20 along two circumferential lines. This attachment of foil to cover has the advantage of making the wheel assembly easy to manipulate as a single object, facilitating installation, removal, storage, and transport.

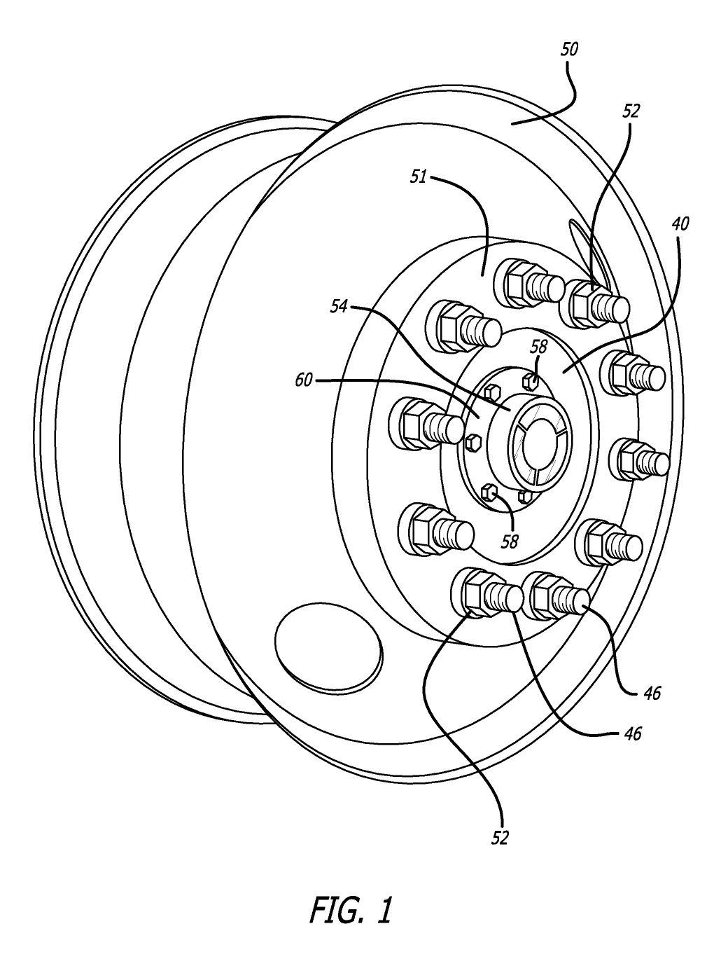

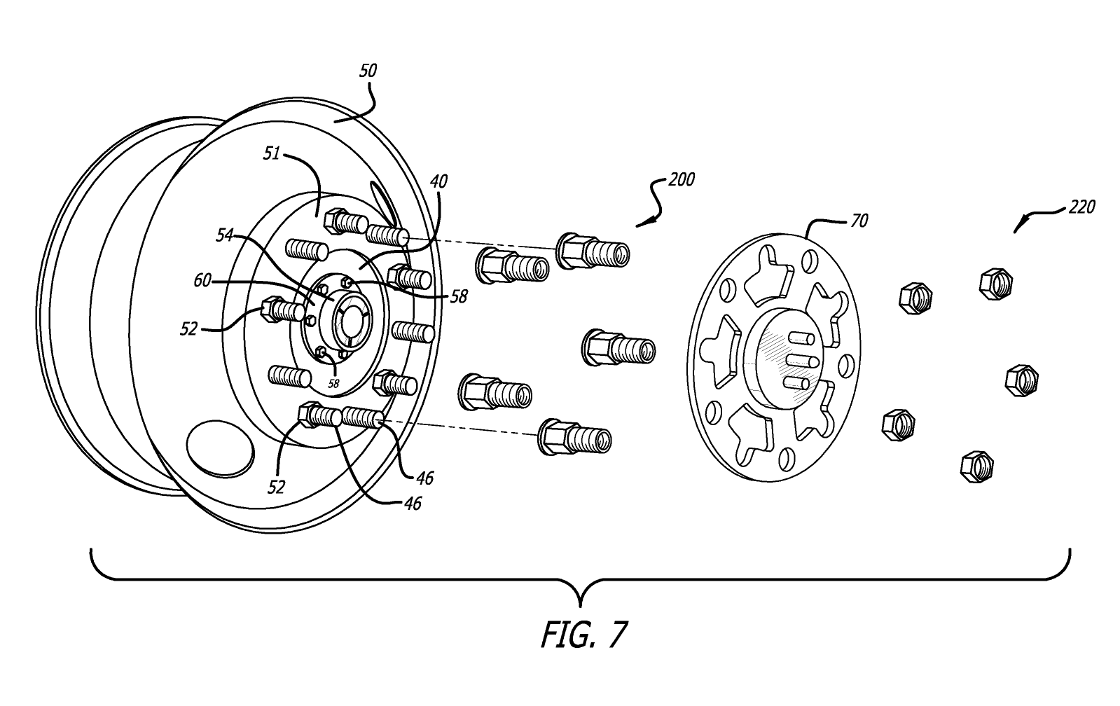

Prior to turning to the structure for connecting the cover assembly to the vehicle wheel, there will be described with reference to FIGS. 1, 7, 8 and 9 certain features commonly found on large trucks that may provide the foundation for a device and method of connection of the present wheel covering system. Typically, the front axle 40 of a truck is the steering axle, and its terminal end commonly includes a number of features. An outer cylinder 44 (FIGS. 8 and 9) acts as a hub and includes a number of lug bolts 46 (FIGS. 1 and 7) protruding outwardly to be inserted through receiving holes 48 in the wheel 50 and to be covered by hex-head nuts 52 that will be tightened to a specified torque for proper operation and safety of the wheel in motion.

For the steering axle, there are commonly found three types of axle caps, (1) oil, (2) grease, and (3) non-serviceable. One of such axle caps 54 (also referred to as hub caps) of a kind typically found on a steering axle may be commonly attached to the proximal end of the outer cylinder 44 and shown in FIG. 1. The outer cylinder and hub cap rotate with the axle 40. The hub cap 54 is fixed to the axle 40 by a plurality of hub cap bolts 58 inserted through an external flange 60 on the hub cap, and into threaded hub cap holes 62 (FIGS. 8 and 9) in the axle.

Turning now to a mounting member and mechanism configured to match and attach the cover assembly to an axle 40, it has been determined that affixing the mounting member to lug bolts 46 in the following manner may be achieved, without impinging upon the integrity or safety of the wheel 50 connection to the axle 40. The connection described can produce a robust and effective connection capable of safely holding a heavy cover assembly of about 40 pounds under acceleration, deceleration, and that overcome shortcomings in the art.

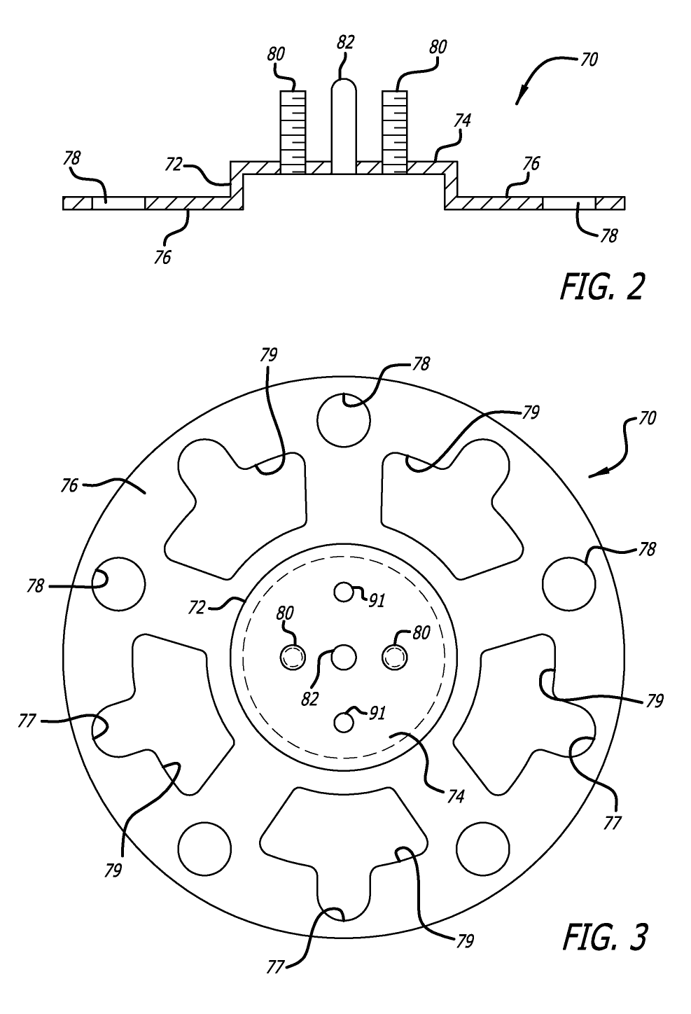

In a preferred embodiment, and as best seen in FIGS. 2 and 3, a mounting member 70 or connector is provided for operation as a structural connection between the lugs 46 and the cover assembly 20, 24 for operation of the wheel covering assembly of the present invention. The mounting member 70 includes a cylindrical portion 72 that, in a preferred embodiment, is fabricated to include a spun or cast steel cylinder which, in a preferred embodiment is 3-4 mm thick. A capping portion 74 takes the form of a flat steel disc that may be welded to the proximal edge of the cylindrical portion 72. A radially external flange 76 is made as a flat steel plate annulus that may be welded to the distal edge of the cylindrical portion 72. Preferably, the flange plate 76 is between 4 and 7 mm thick. Circular holes 78 are drilled into the flange 76 preferably to correspond with the locations of every other one of the lugs 46 holding the wheel 50 to the axle 40. Additional holes 79 are cut into the flange plate 76, each having a portion 77 that corresponds with the locations of the remaining lugs 46, and additional metal is also removed from the plate 76 to reduce the weight of the plate, but without impairing its structural integrity. On the capping portion 74 of the mounting member 70, two threaded studs 80 are fixed and are preferably spaced equidistant from the center of the capping portion 74, diametrically opposite one another. On the center of the capping portion 74 a threadless guide spindle 82 may be fixed, preferably having a length that is about one half an inch longer than the flanking threaded studs 80 and having a diameter that is about the same as the studs, preferably 10-14 mm.

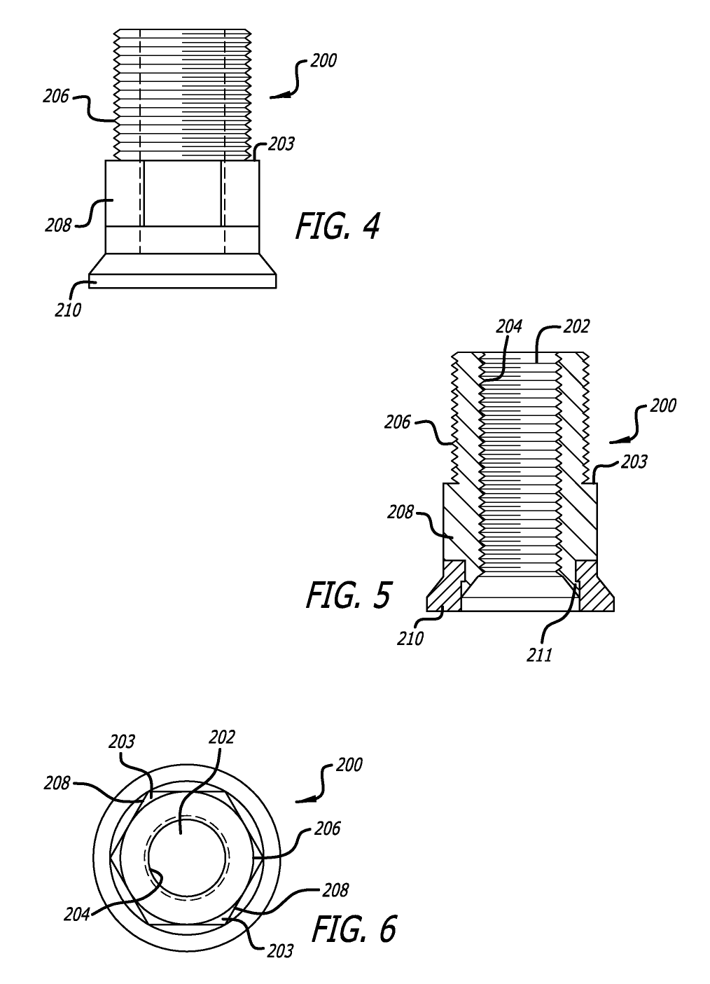

When the mounting member 70 is attached to a steering hub according the present invention, instead of exclusively using the nuts 52 that would ordinarily hold the wheel 50 onto the axle 40, nuts with a novel and advantageous design are used for holding the mounting member 70 to the lugs 46 in a way that does not interfere with the attachment of the wheel to the axle. Specifically, a combination nut 200 suitable for this purpose is described in detail with reference to FIGS. 4-6. In a preferred embodiment, the combination nut 200 which has been developed for use in combination with the mounting member 70 of the present invention has the following features. The combination nut 200 defines a central bore 202 with an internal threaded surface 204, configured to mate with external threads on the lugs 46. The external surface of the combination nut 200 defines an upper external threaded portion 206 which terminates in a solid shoulder 203. The shoulder marks a junction point between the external threaded portion 206 and a lower external hexagonal portion 208 for receiving a torquing tool such as a wrench. Below the hexagonal portion 208 is a splayed footing 210 for spreading load and reducing torquing friction. In a preferred embodiment, the splayed footing 210 may take the form of an annulus (as seen in FIGS. 4 and 5), that may rotate independently of the rest of the nut 200. The annular splayed footing 210 may be secured to the rest of the nut by a radially outwardly turning portion 211 of the nut that may be pressed outwardly by a conical tool after the footing 210 is inserted over it. This aspect allows the footing 210 to remain with the nut 200, preventing it from becoming separated in use. When the combination nut 200 is torqued onto the lug 46, the played footing 210 rotates in relation to the rest of the nut 200, but remains substantially stationary in relation to the wheel, thereby reducing rotation of the nut against the wheel 50 and tending to reduce damage by the nut to the wheel. Additionally, the footing distributes load, further reducing damage to the wheel 50.

As best seen in FIG. 9, the combination nut 200 is used firstly to replace a regular nut 52 which ordinarily connects only the wheel 50 to the axle. In a first embodiment, each of the regular nuts 52 may be replaced by a combination nut, but in a second preferred embodiment, every alternate nut may be replaced, as exemplified in FIG. 7.

Thus, to install the mounting member 70 according to a preferred embodiment of the present invention, every alternate regular nut 52 is first removed from lugs 46. It will be appreciated that this way, the wheel remains securely on the axle 40, held by one half the regular number of nuts 52. Then, the combination nuts 200 are screwed down on the free lugs 46 so that the internal threads 204 of the combination nuts 200 are positioned to engage with external threads of the free lugs 46. Each nut 200 is torqued down directly onto the wheel 50 to the same torque as usually applied to the regular nut 52, in order to hold the wheel onto the axle 40. Once the regular nuts 52 have been replaced by the combination nuts 200 of the present invention, the mounting member 70 is positioned to straddle across the axle cap 54, and each combination nut 200 is slipped through a corresponding hole in the mounting member until the distal surface of the flange 76 rests on the shoulder 203 of each combination nut 200. At this point, a holding nut 220 is screwed onto the external threads 206 of each combination nut 200, and torqued down onto the flange 76 of the mounting member 70, thereby holding the mounting member securely onto the axle 40. It will be appreciated that the irregular shaped holes 79 include a portion 77 that will permit the lugs 46 bearing the regular nuts 52 to extend through if necessary.

In this way, because the mounting member 70 is attached to the axle 40 proximal to structure that holds the wheel 50 onto the axle 40, the mounting member can be rapidly removed without interfering with the attachment of the wheel to the axle. This has considerable advantage, because the system does not require that either a combination nut 200, or a regular nut 52, be loosened or removed when the mounting member 70 is removed, thus allowing rapid and complete inspection of the wheel attachment system without the need to interfere with the structure that forms the wheel attachment. It will be appreciated that the position of the shoulder 203 along the axial length of each combination nut 200 may be selected during design to provide a support for the flange plate 76 against the force of the holding nut 220, and thus, the mounting member 70, at exactly the correct axial position on the wheel. Thus, by judicious design selection of the position of the shoulder on the combination nut, a variety of different types of axles with different geometries may be fitted with the attachment system of the present invention.

As previously noted, on the capping portion 74 of the mounting member 70, two threaded studs 80 are fixed. These are configured to receive corresponding holes 100 (best seen in FIGS. 8 and 9) in the cover 20. The two threaded studs 80 are preferably spaced equidistant from the center of the capping portion 74, diametrically opposite one another. Moreover, on the center of the capping portion 74 a threadless guide spindle 82 may be fixed, preferably having a length that is about half an inch longer than the flanking threaded studs 80 and having a diameter that is about the same as the studs, preferably 10-14 mm. The cover 20 has three mating holes 100 to receive the spindle 82 first, and then the flanking studs 80. Covering nuts 86 are screwed down onto the studs 80 to secure the cover assembly onto the mounting member 70. Preferably, the covering nuts 86 are configured to have a unique circumferential profile so that the manufacturer may provide a mating socket for use by a vehicle owner. Such unique profile and mating socket, in effect, provides a key to the owner, making it extremely difficult for miscreants to remove the cover assembly without permission. A closing cap 88 may be inserted into a recess 90 in the cover 20 to protect and conceal the spindle, studs, the covering nuts, and related assembly. The closing cap 88 may be held in the recess 90 by two bolts 89 configured to pass through the cover 20 and mate with two threaded holes 91 (FIG. 3) in the capping portion 74 for securing the closing cap 88 flush with the external surface of the cover 20. In a preferred embodiment, the floor 93 of the recess 90 is flat, thus allowing a stable and wobble free connection to be formed between the cover 20 and the mounting member 70 when the covering nuts 86 are tightened to compress the floor against the mounting member.

Thus, under a preferred embodiment, the mounting member 70 includes two threaded studs 80 and an additional spindle 82 for attaching the cover assembly to the hub. In light of the considerable weight of the cover assembly, two studs and corresponding nuts provide a degree of redundancy and safety in case one of the nuts should come loose. Furthermore, by providing two studs offset from the center, the capacity to withstand the rotational momentum applied by the cover assembly is greatly increased. It will be appreciated that the weight of the cover assembly, perhaps in the vicinity of 40 pounds, is much greater than in the case of a regular passenger automobile, and thus unbalanced angular momentum of the cover assembly caused by sudden braking may be substantial. The provision of a redundant second stud and nut combination, offset from the center of the cover, is advantageous in dealing with such momentum.

Moreover, in addition to the rotational forces exerted by the cover assembly, an additional force may be exerted as a shear force when the cover 20 is subject to an impact such as may be applied when hitting a curb, bollard, or other object, a not uncommon experience in the lifetime of a wheel cover. The ability of the wheel covering system to withstand these forces is greatly enhanced by the addition of the central spindle 82, so that three separate protrusions (the two studs 80 and the spindle 82) are provided to withstand shear forces caused by impact.

An additional advantage provided by the central spindle 82 in combination with two studs 80 is firstly that the spindle provides a guide pin to facilitate installing the cover assembly. A feature of the cover 20 provided to facilitate installation on the hub is that the central hole 100 on the cover 20 may be configured to terminate, on the inside face, in a conical taper 101 (FIG. 9). Thus, because the spindle 82 is about half an inch longer than the flanking studs 80, the installer is able to locate the central spindle 82 in the central hole 100 by sliding the cover past the spindle. When the spindle falls into the cone 101, the installer knows that he has found the correct hole, and pushes the cover assembly inwards so that its significant weight is taken by the spindle 82. Then, by rotating the cover assembly somewhat, the installer may easily align the studs 80 with their corresponding holes 100, and push the cover assembly onto the studs 80 before installing and tightening the covering nuts 86. The longer spindle feature eliminates the difficulty of having to simultaneously manually support the full weight of the cover assembly and find the correct cover alignment with respect to the two studs 80 before the cover assembly may be pressed over the studs.

It will be appreciated that the structure described has the advantage of providing a versatile and easy to use attachment system, attachable and detachable without adversely affecting the security of the wheel attachment to the axle.

Thus, it is seen that the covering system of the present invention provides novel and useful features for covering certain kinds of wheel hubs, and overcoming shortcomings in the prior art. The present invention may, of course, be carried out in other specific ways than those herein set forth without departing from the essential characteristics of the invention. The present embodiments are, therefore, to be considered in all respects as illustrative and not restrictive, and all changes coming within the meaning and equivalency range of the appended claims are intended to be embraced therein.

We claim:

1. A wheel covering system for attachment to a vehicle axle, in which the axle has a plurality of externally threaded lugs for attaching a wheel to the axle, the system comprising:
an ornamental cover configured to be positioned adjacent the wheel;
a mounting member configured to be attached to the axle after the wheel is positioned on the axle, the mounting member having a distal end and a proximal end, wherein the distal end defines a plurality of holes corresponding to locations of the lugs, and wherein the proximal end is configured to attach the ornamental cover to the mounting member;
at least one combination nut, characterized in that said at least one combination nut includes:
a bore with internal threads configured to mate with external threads on one of the lugs thereby to attach the combination nut to the lug;
an external hexagonal portion for torquing the combination nut onto the lug thereby to secure the wheel onto the axle;
an external threaded portion configured to pass through one of the holes in the mounting member, and also configured to receive a holding nut for attaching the mounting member to the combination nut.

2. The system of claim 1, wherein the combination nut defines a shoulder between the external threaded portion and the external hexagonal portion, the shoulder being sized to not pass through the hole in the mounting member, whereby the shoulder acts as a support to the mounting member.

3. The system of claim 1, wherein the combination nut includes an annular footing portion at a terminal end of the combination nut, the footing portion being capable of independent rotation in relation to the combination nut.

4. The system of claim 3, wherein the hexagonal portion has a first external diameter and the footing portion has a second external diameter, and wherein the second diameter is larger than the first diameter.

5. The system of claim 1, wherein the distal end of the mounting member includes an annular metal plate.

6. The system of claim 1, wherein the proximal end of the mounting member includes a cylinder closed with a capping portion.

7. The system of claim 6, wherein two threaded studs extend proximally from the capping portion, the threaded studs being positioned diametrically opposite each other across a center point of the capping portion.

8. The system of claim 7, wherein a spindle extends proximally from the capping portion, the spindle being positioned between the two studs and being longer than the two studs.

9. A method of attaching an ornamental hub to a vehicle axle, the axle having a plurality of externally threaded lugs, the method comprising;
inserting the threaded lugs through corresponding holes in a wheel so that the wheel is positioned on the axle;
providing a combination nut having both an internal threaded bore and an external threaded portion;
threading the internal bore of the combination nut onto the external thread of a lug to attach the wheel to the axle, and to attach the combination nut to the lug;
inserting the external threaded portion of the combination nut through a hole in a mounting member so that the mounting member is adjacent the wheel;
threading a holding nut onto the external threaded portion of the combination nut to attach the mounting member to the combination nut;
inserting at least one stud extending proximally from the mounting member through a hole in the ornamental hub so that the ornamental hub is adjacent the mounting member;
threading a nut onto the stud to attach the ornamental hub to the mounting member, whereby the ornamental hub is attached to the axle.

10. The method of claim 9, wherein inserting at least one stud through a hole in the ornamental hub includes inserting two studs, each through a respective hole in the ornamental hub.

11. The method of claim 9, further including, prior to inserting at least one stud, inserting a spindle, centrally positioned on and extending proximally from the mounting member, through an additional hole in the ornamental hub, such that the spindle enters the additional hole before the stud enters the hole in the ornamental hub.

12. The method of claim 9, wherein threading a holding nut onto the external threaded portion of the combination nut includes supporting the mounting member with a shoulder on the combination nut that has a larger diameter than the hole in the mounting member.

13. A wheel covering system for attachment to a vehicle axle, in which the axle has a plurality of externally threaded lugs for insertion through holes in a wheel to attach the wheel to the axle, the system comprising:
a combination nut that includes:
a bore with internal threads configured to mate with the external threads on one of the lugs, thereby to attach the combination nut to the lug;
an external hexagonal portion for torquing the combination nut onto the lug thereby to secure the wheel onto the axle;
an external threaded portion;
an ornamental cover configured to be positioned adjacent the wheel;
a mounting member configured to be attached to the combination nut, the mounting member having a distal end and a proximal end;
wherein the proximal end is configured to attach the ornamental cover to the mounting member,
wherein the distal end defines a plurality of holes corresponding to locations of the lugs;
wherein at least one hole is sized to receive the external threaded portion of the combination nut; and
wherein the external threaded portion of the combination nut is sized to receive a threaded holding nut to secure the mounting member to the combination nut.

14. The system of claim 13, wherein the combination nut defines a shoulder between the external threaded portion and the external hexagonal portion, the shoulder being sized to not pass through the at least one hole in the mounting member, whereby the shoulder acts as a support to the mounting member.

15. The system of claim 13, wherein the combination nut includes an annular footing portion at a terminal end of the combination nut, the footing portion being capable of independent rotation in relation to the combination nut.

16. The system of claim 15, wherein the hexagonal portion has a first external diameter and the footing portion has a second external diameter, and wherein the second diameter is larger than the first diameter.

17. The system of claim 13, wherein the distal end of the mounting member includes an annular metal plate between 4 and 7 mm thick.

18. The system of claim 13, wherein the proximal end of the mounting member includes a cylinder closed with a capping portion.

19. The system of claim 18, wherein two threaded studs extend proximally from the capping portion, the threaded studs being positioned diametrically opposite each other across a center point of the capping portion.

20. The system of claim 19, wherein a spindle extends proximally from the capping portion, the spindle being positioned between the two studs and being longer than the two studs.
